(19) United States
(12) Patent Application Publication
(10) Pub. No.: US 2022/0395102 A1
(43) Pub. Date: Dec. 15, 2022

(54) Climate Controlled Seating Booth Apparatus

(71) Applicant: Chloe Radach, Moses Lake, WA (US)

(72) Inventor: Chloe Radach, Moses Lake, WA (US)

(21) Appl. No.: 17/343,463

(22) Filed: Jun. 9, 2021

(51) Int. Cl. A47C 7/74; A47B 83/02; A47C 7/72; G07F 17/08

(52) U.S. Cl. CPC A47C 7/748; A47B 83/023; A47C 7/723; A47C 7/746; G07F 17/08

(57) ABSTRACT

A climate controlled seating booth apparatus for allowing patrons to control their seat temperature includes a booth having a booth bottom portion, a booth back portion, a booth bottom side, a booth top side, a booth left side, a booth right side, a booth front side, a booth back inner side, and a booth bottom inner side. A back cushion is coupled to the booth back inner side. A bottom cushion is coupled to the booth bottom inner side. A plurality of heating elements is coupled to the back cushion and the bottom cushion. A power source is in operational communication with the plurality of heating elements. A plurality of control buttons coupled to a control panel sets power levels and areas of activation for the plurality of heating elements. A pay terminal receives payment to activate the control panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to seating devices and more particularly pertains to a new seating device for allowing patrons to control their seat temperature. The present device allows for temperature control of either individual portions of a booth or the entire booth. There is a pay terminal allowing establishments to monetize the device.

### (2) Description of Related Art Including Information Disclosed Under 37 CFR 1.97 and 1.98

The prior art relates to seating devices. Existing devices have integrated temperature control, yet for booth style seating the temperature control is evenly administered. These devices lack controls to independently heat or cool just the booth bottom or booth back, or to control independent seats of the booth.

### BRIEF SUMMARY OF THE INVENTION

An embodiment of the disclosure meets the needs presented above by generally comprising a booth having a booth bottom portion, a booth back portion, a booth bottom side, a booth top side, a booth left side, a booth right side, a booth front side, a booth back inner side, and a booth bottom inner side. A back cushion is coupled to the booth, The back cushion is coupled to the booth back inner side. A bottom cushion is coupled to the booth. The bottom cushion is coupled to the booth bottom inner side. A plurality of heating elements is coupled to the back cushion and the bottom cushion. The plurality of heating elements includes a plurality of back heating elements and a plurality of bottom heating elements coupled within the back cushion and the bottom cushion, respectively. A power source is coupled to the booth. The power source is in operational communication with the plurality of heating elements. A control panel is in operational communication with the power source and the plurality of heating elements. A plurality of control buttons is coupled to the control panel. The control buttons are in operational communication with the control panel to set power levels and areas of activation for the plurality of heating elements. A pay terminal is coupled to the control panel. The pay terminal is in operational communication with the control panel and is configured to receive payment to activate the control panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a climate controlled seating booth apparatus according to an embodiment of the disclosure.

FIG. 2 is an isometric view of an embodiment of the disclosure.

FIG. 3 is a side elevation view of an embodiment of the disclosure.

FIG. 4 is a detail view of an embodiment of the disclosure.

FIG. 5 is a side elevation in-use view of an embodiment of the disclosure.

FIG. 6 is a cross-sectional view of an embodiment of the disclosure along the line 6-6 of FIG. 3.

### DETAILED DESCRIPTION OF THE INVENTION

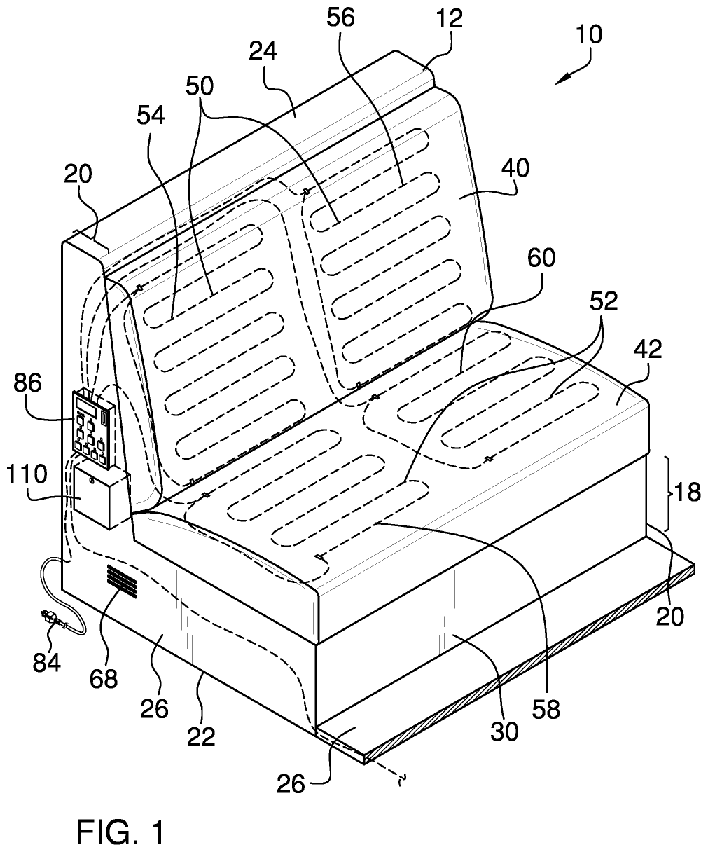

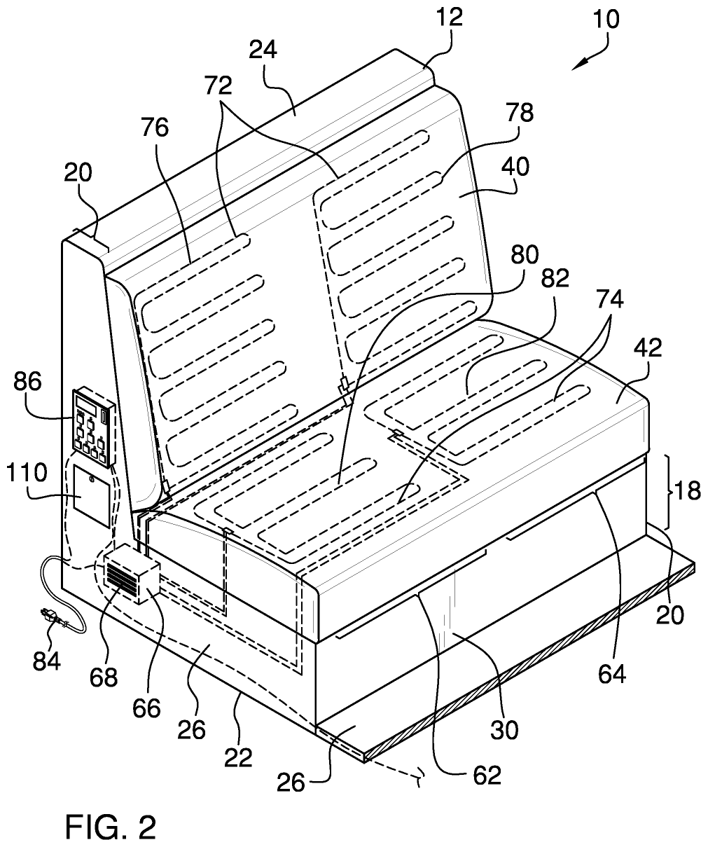

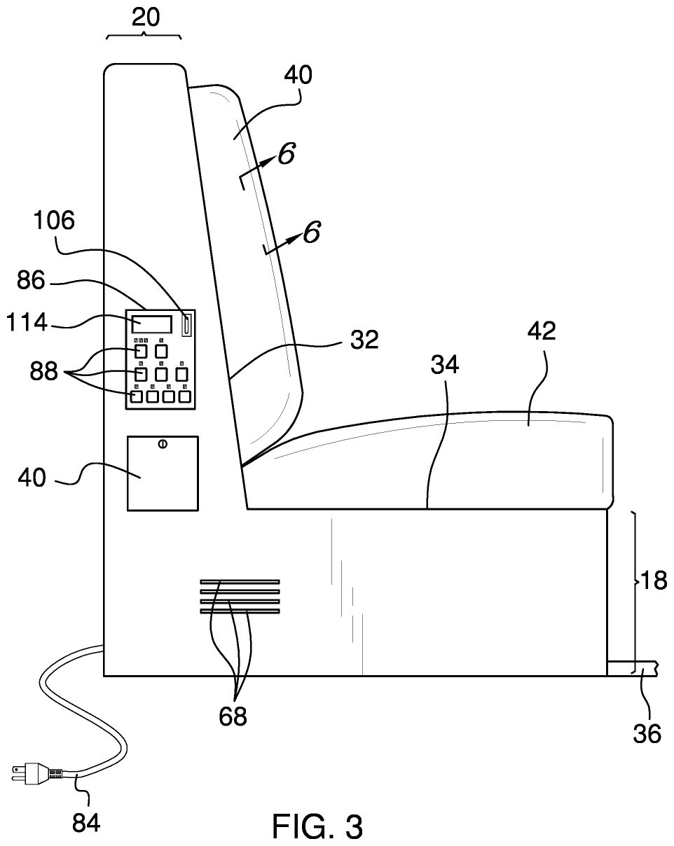

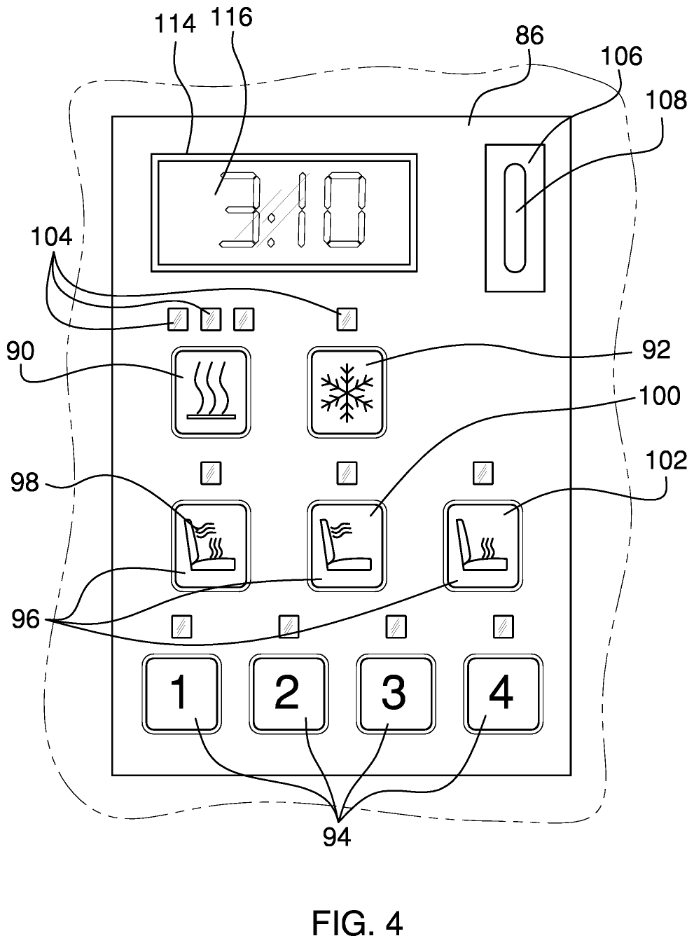

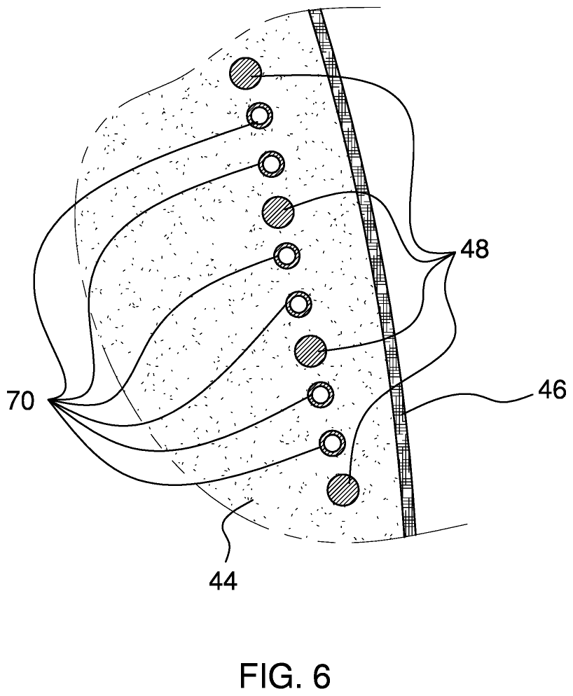

With reference now to the drawings, and in particular to FIGS. 1 through 6 thereof, a new seating device embodying the principles and concepts of an embodiment of the disclosure and generally designated by the reference numeral 10 will be described.

As best illustrated in FIGS. 1 through 6, the climate controlled seating booth apparatus 10 generally comprises a booth 12 including a first booth section 14 and a second booth section 16 each having a booth bottom portion 18, a booth back portion 20, a booth bottom side 22, a booth top side 24, a booth left side 26, a booth right side 28, a booth front side 30, a booth back inner side 32, and a booth bottom inner side 34. The first booth section 14 and the second booth section 16 may be joined by a connector section 36 extending from the booth front sides 30. The connector section 36 may be configured to receive a table 38. The booth back inner side 32 and the booth bottom inner side 34 may form an angle greater than or equal to 90° to create an upright or slightly reclined back support.

A back cushion 40 is coupled to the booth 12. The back cushion 40 is coupled to the booth back inner side 32 and extends from the booth left side 26 to the booth right side 28. A bottom cushion 42 is coupled to the booth 12. The bottom cushion 42 is coupled to the booth bottom inner side 34 and extends from the booth left side 26 to the booth right side 28 and from the booth back inner side 32 to the booth front side 30. Each of the back cushion 40 and the bottom cushion 42 may comprise an inner stuffing 44 for user comfort and an outer cover 46. The outer cover 46 may be leather, vinyl, or any other material traditionally used in seating.

A plurality of heating elements 48 is coupled to the back cushion 40 and the bottom cushion 42. The plurality of heating elements 48 includes a plurality of back heating elements 50 and a plurality of bottom heating elements 52 coupled within the back cushion 40 and the bottom cushion 42, respectively, the plurality of back heating elements 50 may include a plurality of back left heating elements 54 and a plurality of back right heating elements 56. The plurality of bottom heating elements 52 may include a plurality of bottom left heating elements 58 and a plurality of bottom right heating elements 60. The plurality of heating elements 48 can thus be independently zoned for the buttocks and back of a left seat area 62 and a right seat area 64 of each of the first booth section 14 and the second booth section 16.

A chiller 66 may be coupled within the booth 12. The chiller 66 may be coupled to the booth left side 26 with the booth left side 26 having a plurality of vent apertures 68 extending through adjacent the chiller 66 to allow for airflow. A plurality of cooling tubes 70 is in operational communication with the chiller 66 and includes a plurality of back cooling tubes 72 and a plurality of bottom cooling tubes 74 coupled within the back cushion 40 and the bottom cushion 42, respectively. The plurality of back cooling tubes 72 includes a plurality of back left cooling tubes 76 and a plurality of back right cooling tubes 78. The plurality of bottom cooling tubes 74 includes a plurality of bottom left cooling tubes 80 and a plurality of bottom right cooling tubes 82. The plurality of cooling tubes 70 can thus be independently zoned for the buttocks and back of the left seat area 62 and the right seat area 64 of each of the first booth section 14 and the second booth section 16 like the plurality of heating elements 48.

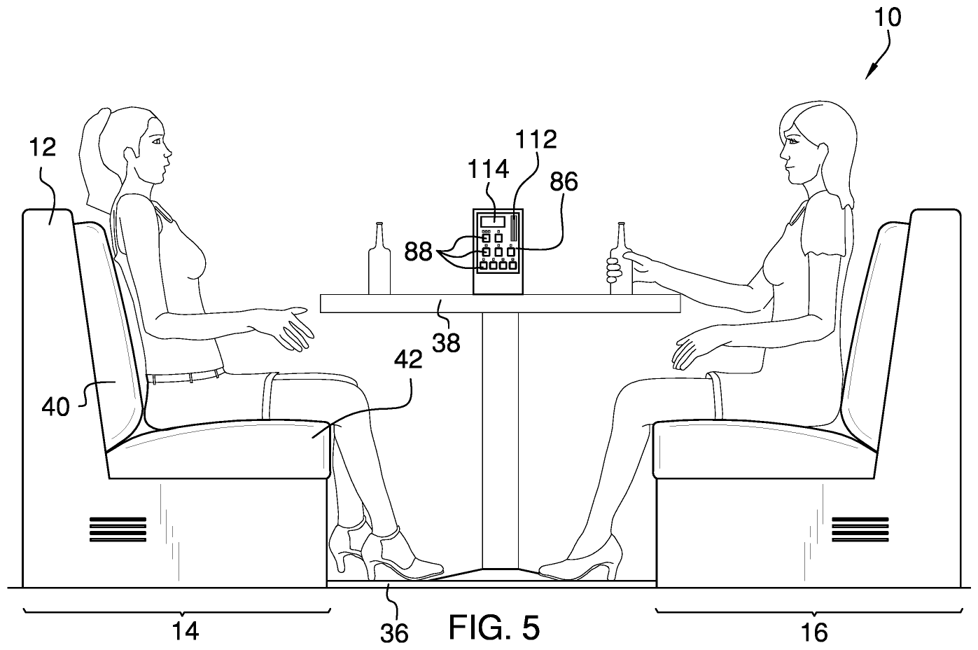

A power source 84 is coupled to the booth 12. The power source 84 is in operational communication with the plurality of heating elements 48 and the chiller 66. A control panel 86 is in operational communication with the power source 84, the plurality of heating elements 48, and the chiller 66. The control panel 86 may be coupled to the booth left side 26 or may alternatively be positioned on the table 38 as seen in FIG. 5.

A plurality of control buttons 88 is coupled to the control panel 86. The control buttons 88 are in operational communication with the control panel 86 to set power levels and areas of activation for the plurality of heating elements 48 and the plurality of cooling tubes 70 with a heat button 90 and a cooling button 92. The plurality of control buttons 88 may include a set of seat selector buttons 94 and a set of back-bottom buttons 96. The set of back-bottom buttons 96 includes a both button 98, a back button 100, and a bottom button 102. A plurality of indicator lights 104 may be coupled to the control panel 86 and are in operational communication with the plurality of control buttons 88.

A pay terminal 106 is coupled to the control panel 86. The pay terminal 106 is in operational communication with the control panel 86 and is configured to receive payment to activate the control panel 86 to allow for use. The pay terminal 106 may include a coin slot 108 in operational communication with a lockable coin box 110 coupled within the booth left side 26, as shown in FIGS. 1-3. The pay terminal 106 may alternatively include a credit card reader 112 as shown in FIG. 5. A timer 114 is coupled to the control panel 86 and is in operational communication with the pay terminal 106 to activate for a predetermined length of time based on how much money is tendered by the pay terminal 106. The timer 114 may have a digital display 116 to indicate how much time remains.

In use, pay is tendered at the pay terminal 106. The plurality of control buttons 88 is then used to opt for heating or cooling as well as which portions of the booth 12 are to be affected. The users may then sit in comfort as for use as a traditional booth seat.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A climate controlled seating booth apparatus comprising:
a booth having a booth bottom portion, a booth back portion, a booth bottom side, a booth top side, a booth left side, a booth right side, a booth front side, a booth back inner side, and a booth bottom inner side;
a back cushion coupled to the booth, the back cushion being coupled to the booth back inner side;
a bottom cushion coupled to the booth, the bottom cushion being coupled to the booth bottom inner side;
a plurality of heating elements coupled to the back cushion and the bottom cushion, the plurality of heating elements including a plurality of back heating elements and a plurality of bottom heating elements coupled within the back cushion and the bottom cushion, respectively;
a power source coupled to the booth, the power source being in operational communication with the plurality of heating elements;
a control panel in operational communication with the power source and the plurality of heating elements;
a plurality of control buttons coupled to the control panel, the control buttons being in operational communication with the control panel to set power levels and areas of activation for the plurality of heating elements; and
a pay terminal coupled to the control panel, the pay terminal being in operational communication with the control panel and configured to receive payment to activate the control panel.

2. The climate controlled seating booth apparatus of claim 1 further comprising the booth including a first booth section and a second booth section joined by a connector section extending from the booth front sides.

3. The climate controlled seating booth apparatus of claim 1 further comprising the plurality of back heating elements including a plurality of back left heating elements and a plurality of back right heating elements, the plurality of bottom heating elements including a plurality of bottom left heating elements and a plurality of bottom right heating elements; the plurality of control buttons including a set of seat selector buttons and a set of back-bottom buttons.

4. The climate controlled seating booth apparatus of claim 3 further comprising the set of back-bottom buttons including a both button, a back button, and a bottom button.

5. The climate controlled seating booth apparatus of claim 1 further comprising a timer coupled to the control panel, the timer being in operational communication with the pay terminal to activate for a predetermined length of time based on how much money is tendered by the pay terminal.

6. The climate controlled seating booth apparatus of claim 5 further comprising the timer having a digital display.

7. The climate controlled seating booth apparatus of claim 1 further comprising the pay terminal including a coin slot.

8. The climate controlled seating booth apparatus of claim 1 further comprising the pay terminal including a credit card reader.

9. The climate controlled seating booth apparatus of claim 1 further comprising a chiller coupled within the booth; a plurality of cooling tubes coupled to the back cushion and the bottom cushion, the plurality of cooling tubes including a plurality of back cooling tubes and a plurality of bottom cooling tubes coupled within the back cushion and the bottom cushion, respectively.

10. The climate controlled seating booth apparatus of claim 9 further comprising the plurality of back cooling tubes including a plurality of back left cooling tubes and a plurality of back right cooling tubes, the plurality of bottom cooling tubes including a plurality of bottom left cooling tubes and a plurality of bottom right cooling tubes.

11. The climate controlled seating booth apparatus of claim 9 further comprising the chiller being coupled to the booth left side, the booth left side having a plurality of vent apertures extending through adjacent the chiller.

12. A climate controlled seating booth apparatus comprising:
a booth including a first booth section and a second booth section each having a booth bottom portion, a booth back portion, a booth bottom side, a booth top side, a booth left side, a booth right side, a booth front side, a booth back inner side, and a booth bottom inner side, the first booth section and the second booth section joined by a connector section extending from the booth front sides;
a back cushion coupled to the booth, the back cushion being coupled to the booth back inner side;
a bottom cushion coupled to the booth, the bottom cushion being coupled to the booth bottom inner side;
a plurality of heating elements coupled to the back cushion and the bottom cushion, the plurality of heating elements including a plurality of back heating elements and a plurality of bottom heating elements coupled within the back cushion and the bottom cushion, respectively, the plurality of back heating elements including a plurality of back left heating elements and a plurality of back right heating elements, the plurality of bottom heating elements including a plurality of bottom left heating elements and a plurality of bottom right heating elements;
a chiller coupled within the booth, the chiller being coupled to the booth left side, the booth left side having a plurality of vent apertures extending through adjacent the chiller;
a plurality of cooling tubes coupled to the back cushion and the bottom cushion, the plurality of cooling tubes being in operational communication with the chiller and including a plurality of back cooling tubes and a plurality of bottom cooling tubes coupled within the back cushion and the bottom cushion, respectively, the plurality of back cooling tubes including a plurality of back left cooling tubes and a plurality of back right cooling tubes, the plurality of bottom cooling tubes including a plurality of bottom left cooling tubes and a plurality of bottom right cooling tubes;
a power source coupled to the booth, the power source being in operational communication with the plurality of heating elements and the chiller;
a control panel in operational communication with the power source and the plurality of heating elements;
a plurality of control buttons coupled to the control panel, the control buttons being in operational communication with the control panel to set power levels and areas of activation for the plurality of heating elements, the plurality of control buttons including a set of seat selector buttons and a set of back-bottom buttons, the set of back-bottom buttons including a both button, a back button, and a bottom button;
a pay terminal coupled to the control panel, the pay terminal being in operational communication with the control panel and configured to receive payment to activate the control panel; and
a timer coupled to the control panel, the timer being in operational communication with the pay terminal to activate for a predetermined length of time based on how much money is tendered by the pay terminal, the timer having a digital display.
